(19) United States
(12) Patent Application Publication
(10) Pub. No.: US 2015/0211696 A1
(43) Pub. Date: Jul. 30, 2015

(54) MULTI-LAMP DECORATING CURTAIN LIGHT

(71) Applicant: HUNG-HUEI CHENG, Hsinchu (TW)

(72) Inventor: HUNG-HUEI CHENG, Hsinchu (TW)

(21) Appl. No.: 14/166,871

(22) Filed: Jan. 29, 2014

(51) Int. Cl. F21S 4/00

(52) U.S. Cl. CPC F21S 4/002; F21Y 2111/00

(57) ABSTRACT

The present invention is related to a multi-lamp decorating curtain light with a split string having illuminating elements each of which is assembled by two or more decorating lamps into one illuminating element by means of wire winding when connecting the wire of the split string with the decorating lamps.

Thereby each illuminating element on each split string is in a cluster format constituted by the multiply decorating lamps in order to achieve the better decorating effectiveness by the enhanced flashing mode.

### TECHNICAL FIELD OF THE INVENTION

The present invention is related to an improvement on the structure of a decorating light, particularly an improvement on a split string of a decorating curtain light.

### DESCRIPTION OF THE PRIOR ART

The structure of an ordinary decorating curtain light includes a stem wire and a plurality of split strings provided on the stem wire in parallel arrangement so as to constitute a format of curtain light. The split string of the decorating curtain light of the prior art is an extension wire on which a plurality of decorating lamps is assembled at a set interval distance in order to achieve the flashing mode. However, the split strings of the decorating curtain light of the prior art has a single decorating lamp as one illuminating element from which the light illuminated can only achieve relatively inadequate decorating effectiveness.

According to the deficiency of decorating light of the prior art, the inventor of the present invention previously worked out an improvement with a patent application granted with approval of U.S. Pat. No. 6,445,136. The inventor worked on continuous improvement resulting in a multi-lamp decorating curtain light of the present invention with further advantage in economic and utility.

### SUMMARY OF THE INVENTION

An objective of the present invention is to provide a multi-lamp decorating curtain light to assemble two or more decorating lamps into one illuminating element by means of wire winding when connecting a wire with the decorating lamps so as to make each illuminating element on a split string in a cluster format constituted by the multiply decorating lamps in order to achieve the better decorating effectiveness by the enhanced flashing mode.

### BRIEF DESCRIPTION OF THE DRAWINGS

FIG. 1 is a schematic diagram illustrating the arrangement of the present invention.

FIG. 2 is three-dimensional diagram illustrating a partial structure of the present invention.

### DETAILED DESCRIPTION OF THE PREFERRED EMBODIMENTS

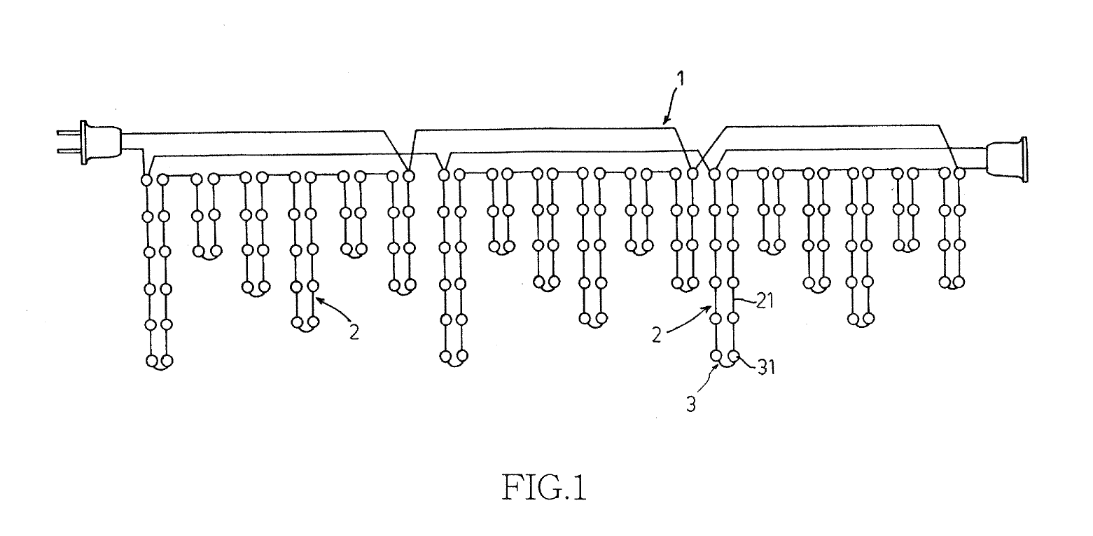

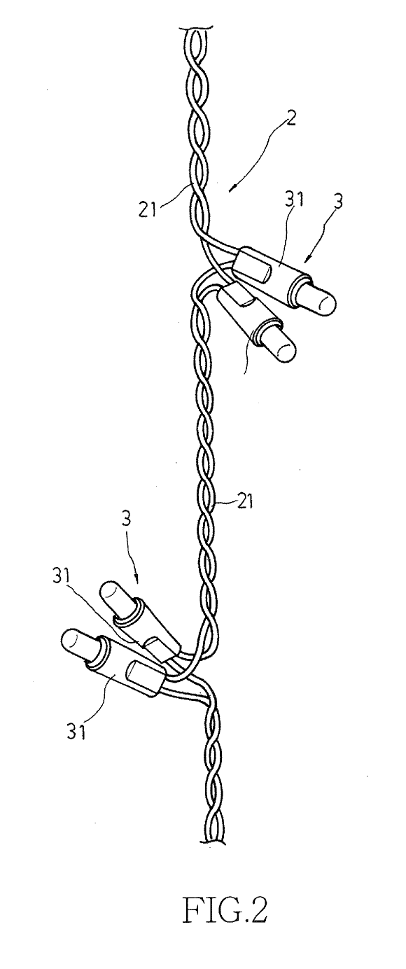

Please refer FIGS. 1 and 2. A multi-lamp decorating curtain light of the present invention includes a stem wire (1) and a plurality of split strings (2), which are made of downward extension wires (21) in parallel arrangement, provided on the stem wire (1) in order to constitute a curtain format. The split string (2) is the extension wire (21) and a plurality of illuminating elements (3) provided at a set interval distance with improvement as characterized that each of the illuminating elements (3) on the split string (2) is an assembly of two decorating lamps (31) by means of wire winding into one illuminating element (3) when connecting the extension wire (21) with the decorating lamps (31). Thereby each of the illuminating elements (3) on the split string (2) is in a cluster format constituted by the multiply decorating lamps.

Through the above-mentioned, each illuminating element on the split string of the present invention achieves a flashing mode of dual decorating lamps resulting in better decorating effectiveness that is beyond the prior art. Further the unprecedented design for constituting the illuminating elements already complies with the novelty and utility for a patent.

I claim:

1. A multi-lamp decorating curtain light comprising a body of decorating light in curtain format with a stem wire, a plurality of split strings, made of downward extension wires in parallel arrangement, and a plurality of illuminating elements, provided on said plurality of split strings at a set interval distance, characterized in that each of said plurality of illuminating elements on said split strings is assembled by two or more decorating lamps by means of wire winding when connecting said extension wires with the decorating lamps so as to make each of said plurality of illuminating elements on said split strings in a cluster format constituted by multiply decorating lamps.

2. The multi-lamp decorating curtain light of claim 1, wherein two or more decorating lamps are assembled into one illuminating element on each of said plurality of split strings.
